(19) United States
(12) Patent Application Publication
(10) Pub. No.: US 2024/0083534 A1
(43) Pub. Date: Mar. 14, 2024

(54) Support Apparatus for Wheeled Vehicles

(71) Applicant: Peak Racks, Inc., San Luis Obispo, CA (US)

(72) Inventors: Rodney J. Hoadley, San Luis Obispo, CA (US); Christopher Skrabanik, Arroyo Grande, CA (US); Case M. Hoadley, San Luis Obispo, CA (US)

(21) Appl. No.: 18/273,000

(22) PCT Filed: Dec. 30, 2021
(86) PCT No.: PCT/US2021/065740

§ 371 Date: Jul. 18, 2023

Related U.S. Application Data
(60) Provisional application No. 63/140,820, filed on Jan. 23, 2021.

(51) Int. Cl. B62H 3/08; B62H 5/14

(52) U.S. Cl. CPC B62H 3/08; B62H 5/14

(57) ABSTRACT

An apparatus for supporting wheeled vehicles in an upright position includes a first elongated wheel support member having a proximal end, a distal end and a pair of first elongated left and right side members connecting the proximal and distal ends, and a second elongated wheel support member having a top end, a bottom end and a pair of second elongated left and right side members connecting the top and bottom ends. The first wheel support member is connected near its distal end to the second wheel support member, and the apparatus further includes a first strut which extends between the first and second left side members and a second strut which extends between the first and second right side members.

### BACKGROUND OF THE INVENTION

### Field of the Invention

The present invention relates generally to storage racks, and more specifically to vehicle storage rack systems for supporting vehicles, such as bicycles, in an upright position.

### Discussion of the Related Art

Various storage rack systems and processes are known in the art.

Some vehicles (e.g., such as unicycles, two wheeled cycles, pogo sticks, etc.) may inherently stay upright while in motion, but at rest must be supported to maintain an upright position. In some cases, various problems may exist when such vehicles are not maintained in an upright position. For instance, two wheeled vehicles (e.g., bicycles) may occupy more space when laid down compared to when standing upright, which may block access to nearby spaces, may result in inefficient usage of storage space, may act as a tripping hazard, etc.

Some two wheeled vehicles, such as bicycles, are affixed with a retractable spring-loaded arm commonly referred to as a “kickstand.” A kickstand can be moved into a position (e.g., with a person's foot or hand) so the arm of the kickstand touches the ground and supports the bicycle upright at a slight angle when the two wheeled vehicle is not in motion. While a kickstand may hold a single bicycle upright, offering easy access to the bicycle in most cases, multiple bicycles parked next to one another all being held by individual kick stands may pose problems such as difficult bicycle retrieval, clutter, a possible domino effect in the event a bicycle is knocked over, etc. Moreover, some two wheeled vehicles (e.g., race bicycles and mountain bikes) may not be equipped with an upright support mechanism such a kickstand. Accordingly, improved apparatuses and techniques for removably securing vehicles that do not naturally stand upright when not in motion may be desired.

### SUMMARY OF THE INVENTION

The present disclosure is directed to an apparatus for supporting wheeled vehicles, such as bicycles, in an upright position. Embodiments of the vehicle support apparatus may include a first elongated wheel support member, a second elongated wheel support member and at least one strut extending between the first and second wheel support members. The first wheel support member comprises a proximal end, a distal end and a pair of first elongated left and right side members connecting the proximal and distal ends. The second wheel support member comprises a top end, a bottom end and a pair of second elongated left and right side members connecting the top and bottom ends. The first wheel support member may be connected near its distal end to the second wheel support member, and this connection may be located above the bottom end to thereby elevate the distal end of the first wheel support member above a horizontal support surface on which the apparatus is positioned.

The at least one strut may extend between either the first and second left side members or the first and second right side members. In one embodiment, the apparatus comprises two struts: a first strut which extends between the first and second left side members and a second strut which extends between the first and second right side members. In this embodiment, the first strut is connected to the first left side member at a first location or connection point and the second strut is connected to the first right side member at a second location or connection point. In addition, the first strut is connected to the second left side member at a third location or connection point, and the second strut is connected to the second right side member at a fourth location or connection point.

In accordance with one embodiment of the invention, the first and second connection points may be spaced unequally from the distal end of the first wheel support member. For example, the first connection point may be located closer to the distal end of the first wheel support member than the second connection point. As an alternative or in addition to this arrangement, the third and fourth connection points may be spaced unequally from the top end of the second wheel support member. For example, the third connection point may be located closer to the top end of the second wheel support member than the fourth connection point.

In one embodiment of the apparatus, the proximal end of the first wheel support member and/or the bottom end of the second wheel support member are connectable to a horizontal support surface. The horizontal support surface may be a floor, the ground, a platform, or any other generally horizontally extending structure or structures. In one example, the proximal end of the first wheel support member may be connected to the horizontal support surface by means of a vertically extending mounting bracket having an upper end portion to which the proximal end is connected and a lower end portion which is bolted or otherwise secured to the horizontal support surface. In this manner, the proximal end of the first wheel support member is elevated above the horizontal support surface. In another example, the bottom end of the second wheel support member is equipped with a horizontal flange which is bolted or otherwise secured to the horizontal support surface.

In accordance with another embodiment of the invention, the apparatus may comprise a first elongated horizontal mounting member to which the mounting bracket is bolted or otherwise secured and/or a second elongated horizontal mounting member to which the bottom end of the second wheel support member is bolted or otherwise secured. In this embodiment, the first and second elongated horizontal mounting members are in turn supported on the horizontal support surface. The first and/or second elongated horizontal mounting members may be made, e.g., of wood, metal, plastic or any other suitable material.

The inventors have observed that if the bicycle wheel positioned in the first wheel support member is allowed to touch the horizontal support surface or the elongated horizontal mounting members (if present), the bicycle may appear unstable. Thus, in accordance with a further embodiment of the invention, the support apparatus is configured to maintain the wheel elevated above the horizontal support surface and/or the elongated horizontal mounting members. For example, if the mounting bracket has a height “a”, the distal end of the first wheel support member is connected to the second wheel support member a distance “b” above the bottom end of the second wheel support member, and the first and second elongated horizontal mounting members, if present, have respective heights “c” and “d” (which could be the same height), the combination of the dimensions a, b, c and d may be selected so that the first wheel support member will elevate the wheel positioned therein above the horizontal support surface (e.g., the floor, the ground, etc.) and the elongated horizontal mounting members (if present). For example, if the elongated horizontal mounting members are not present in a particular configuration of the support apparatus, the dimensions a and b may be selected to maintain the wheel elevated above the horizontal support surface. In a similar manner, if both elongated horizontal mounting members are present, the dimensions a, b, c and d may be selected so that the heights a+c and b+d are sufficient to maintain the wheel elevated above the horizontal support surface and the elongated horizontal mounting members.

The first and second wheel support members, the first and second struts and the vertical mounting bracket are preferably made from a material which is sufficiently strong to adequately support vehicles of different sizes and weights in an upright position. In many applications, such a material may be a suitable metal.

In an illustrative embodiment of the invention, the first wheel support member may take the form of a first elongated metal loop comprising a V-shaped proximal end and a V-shaped distal end, wherein a length of the first elongated metal loop is measured from a base of the V-shaped proximal end to a base of the V-shaped distal end. In addition, the second wheel support member may take the form of a second elongated metal loop comprising a top end and a bottom end. Further, a left side and a right side of the first elongated metal loop are coupled, respectively, to a left side and a right side of the second elongated metal loop closer to the V-shaped distal end than the V-shaped proximal end. In some embodiments, the left side and the right side of the first elongated metal loop are coupled, respectively, closer to the bottom end than the top end. In some embodiments, the second elongated metal loop supports the first elongated metal loop in a position spaced above the horizontal support surface. In some embodiments, this position and the length of the first elongated metal loop are selected so as to secure the vehicle wheel above the horizontal support surface by an amount sufficient so that the wheel does not contact the horizontal support surface.

### BRIEF DESCRIPTION OF THE DRAWINGS

FIG. 1 shows an example of a first embodiment of a vehicle support apparatus according to aspects of the present disclosure.

FIG. 2 shows an example of an apparatus for locking a vehicle to a vehicle support apparatus according to aspects of the present disclosure.

FIGS. 3 through 5 show examples of additional embodiments of vehicle support apparatuses according to aspects of the present disclosure.

FIGS. 6 through 8 show examples of various embodiments of vehicle support system according to aspects of the present disclosure.

FIG. 9 shows an example of a vehicle support apparatus of the type illustrated in FIG. 1.

FIG. 10 shows an example of a mounting bracket for securing a vehicle support apparatus to a horizontal support surface according to aspects of the present disclosure.

FIG. 11 shows an example of a vehicle locking apparatus of the type illustrated in FIG. 2.

### DETAILED DESCRIPTION OF THE INVENTION

The following description is not to be taken in a limiting sense, but is made merely for the purpose of describing the general principles of exemplary embodiments of the invention. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

As described herein, some vehicles (e.g., such as unicycles, bicycles, pogo sticks, etc.) may inherently stay upright while in motion, but at rest may require support to maintain an upright position. In some cases, various problems may exist when such vehicles are not maintained in an upright position. For instance, two wheeled vehicles (e.g., bicycles, dirt bikes, motorcycles, etc.) may occupy more space when laid down compared to when standing upright, which may block access to nearby spaces, may result in inefficient usage of storage space, may act as a tripping hazard, etc.

Some vehicles may be equipped with a support mechanism (e.g., a kickstand) for maintaining an upright position when not in motion. However, access to easily retrieve and replace a single vehicle (e.g., such as a bicycle) is often hindered by such kickstands. Moreover, many two wheeled vehicles (e.g., such as specialty race bicycles, mountain bicycles, etc.) are not equipped with a kickstand and often are leaned up against some object or against another vehicle to remain upright. Such may hinder easy access for retrieval and replacement of the vehicles, as the vehicles may need to be rearranged and balanced against each other to remain upright upon retrieval of one of the vehicles. Additionally, two wheeled vehicles that are not securely supported may fall onto the ground or other objects causing damage to themselves or the other objects.

Consumers have many options with many different types of vehicles that may be equipped with various types and sizes of wheels. For example, race bicycles, commuter bicycles, mountain bicycles, kids bicycles, e-bikes, dirt bikes, etc., all may have different wheel sizes and it may be desirable to efficiently store combinations of these various vehicles in one location. For instance, similar to a bicycle shop that may need various stands to display and easily retrieve and replace bicycles, consumers may desire an easy to set up, variable wheel width, expandable, changeable, lightweight, and portable storage rack that holds various vehicles such as bicycles in an upright position while allowing easy access for retrieval and replacement.

Embodiments of the vehicle support apparatuses described herein generally provide for efficient vehicle storage. For instance, the vehicle support apparatuses may accommodate a variety of vehicles having various wheel types, wheel sizes, tire types, tire sizes, etc.

In some cases, the vehicle support apparatuses described herein may be referred to as a rack, rack unit, storage rack, vehicle rack, bicycle rack, bike rack, bicycle display rack, or storage unit, among other examples. As described in more detail below, the apparatuses described herein may securely hold wheels of various sizes (e.g., wheel and tire sizes ranging from 0.75 inches (20 mm) to 3 inches (76 mm) in width). In some examples, such wheels may be secured such that the vehicles may be maintained in an upright position with the wheel not touching the ground. Generally, a vehicle (e.g., a two wheeled vehicle) may be inserted into the described apparatuses either frontward (e.g., via its front wheel) or backward (e.g., via its back wheel). Vehicles with fenders may also be accommodated.

Further, the vehicle support apparatuses described herein may be free standing, lightweight and mobile, may be used inside or outside, and do not necessarily require level ground to secure the vehicles effectively (e.g., such that the vehicles will remain upright, will not roll out of the rack, etc.).

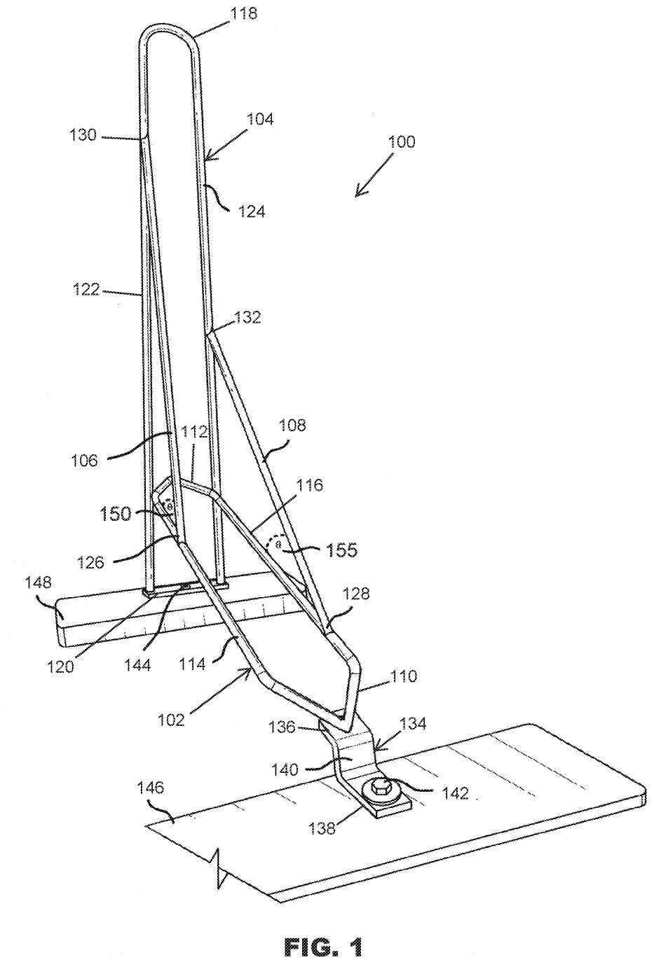

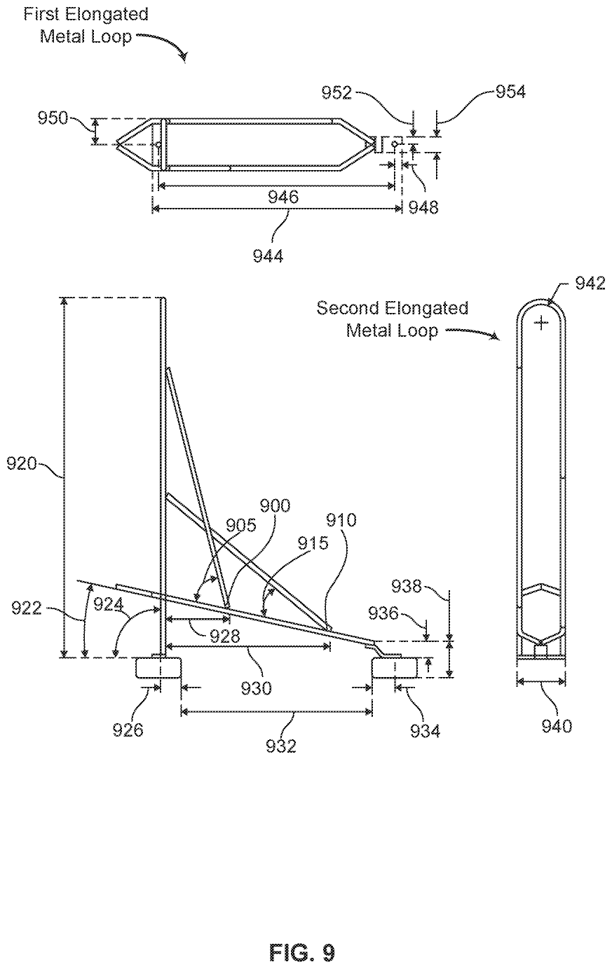

FIG. 1 shows an example of a vehicle support apparatus according to aspects of the present disclosure. In some examples, the apparatus shown in FIG. 1 may be referred to as a slot or slot apparatus (where, e.g., one or more slot apparatuses may be used together in a larger apparatus, which may be referred to as a rack unit). For instance, the apparatus shown in FIG. 1 may be an example of, or may include aspects of, a slot 100 described with reference to FIG. 9.

As shown in FIG. 1, the vehicle support apparatus, which is indicated generally by reference number 100, includes a first elongated wheel support member 102, a second elongated wheel support member 104 and at least one strut 106, 108 extending between the first and second wheel support members. The first wheel support member 102 comprises a proximal end 110, a distal end 112 and a pair of first elongated left and right side members 114, 116 connecting the proximal and distal ends. The second wheel support member 104 comprises a top end 118, a bottom end 120 and a pair of second elongated left and right side members 122, 124 connecting the top and bottom ends. The first wheel support member 102 may be connected near its distal end 112 to the second wheel support member 104, and this connection may be located above the bottom end 120 to thereby elevate the distal end of the first wheel support member 102 above a horizontal support surface on which the vehicle support apparatus 100 is positioned.

The at least one strut 106, 108 may extend between either the first and second left side members 114, 122 or the first and second right side members 116, 124. In one embodiment, the apparatus 100 comprises two struts 106, 108: a first strut 106 which extends between the first and second left side members 114, 122, and a second strut 108 which extends between the first and second right side members 116, 124. In this embodiment, the first strut 106 is connected to the first left side member 114 at a first location or connection point 126, and the second strut 108 is connected to the first right side member 116 at a second location or connection point 128. Also, the first strut 106 is connected to the second left side member 122 at a third location or connection point 130, and the second strut 108 is connected to the second right side member 124 at a fourth location or connection point 132. In the case where the first and second wheel support members 102, 104 and the first and second struts 106, 108 are made of metal, the struts may be connected to the first and second left side members and the first and second right side members by, e.g., welding.

In accordance with one embodiment of the invention, the first and second connection points 126, 128 may be spaced unequally from the distal end 112 of the first wheel support member 102. For example, the first connection point 126 may be located closer to the distal end 112 of the first wheel support member 102 than the second connection point 128. As an alternative or in addition to this arrangement, the third and fourth connection points 130, 132 may be spaced unequally from the top end 118 of the second wheel support member 104. For example, the third connection point 130 may be located closer to the top end 118 of the second wheel support member 104 than the fourth connection point 132.

This unequal spacing of the first and second connection points 126, 128 from the distal end 112 of the first wheel support member 102, and/or the unequal spacing of the third and fourth connection points 130, 132 from the top end 118 of the second wheel support member 104, provides a configuration, such as shown in FIG. 1, which enables the apparatus 100 to accommodate various features of particular vehicles. In the case of a bicycle, for instance, the unequal spacing allows the rear wheel to be secured in the apparatus 100 without the first strut 106 interfering with the derailleur or second strut 108 interfering with disk brake rotors. In addition, the unequal spacing allows either the front or the rear wheel to be secured in the apparatus 100 without the either strut 106,108 interfering with the front or rear disc brake rotors. In a variation of the invention which is not shown in the drawings, the benefits just described may be obtained by simply eliminating one of the struts 106, 108. For example, eliminating the first strut 106 would enable the apparatus to accommodate either the front wheel or the rear wheel without interfering with the derailleur or the disc brake rotors.

In accordance with one embodiment of the invention, the proximal end 110 of the first wheel support member 102 and/or the bottom end 120 of the second wheel support member 104 may be connectable to a horizontal support surface for the apparatus 100. The horizontal support surface may be a floor, the ground, a platform, or any other generally horizontally extending structure or structures.

In one example, the proximal end 110 of the first wheel support member 102 may be connected to the horizontal support surface by means of a mounting bracket 134. As shown in FIG. 1, the mounting bracket 134 has an upper end portion 136 which is vertically spaced from a lower end portion 138 by a middle portion 140. In this example, the proximal end 110 of the first wheel support member 102 is connected such as by welding to the upper end portion 136 and the lower end portion 138 is secured with a bolt 142 or other suitable means to the horizontal support surface. In this manner, the mounting bracket 134 will serve to elevate the proximal end 110 of the first wheel support member 102 above the horizontal support surface. With the distal end 112 of the first wheel support member 102 elevated above the horizontal support surface due to its elevated connection to the second wheel support member 104, this arrangement will enable the vehicle support apparatus 100 to maintain the wheel of the vehicle off of the horizontal support surface. In some embodiments the middle portion 140 of the mounting bracket 134 may define a sloped surface between the upper and lower end portions 136, 138 to facilitate rolling the wheel up the mounting bracket and over the proximal end 110 of the first wheel support member 102.

In addition or as an alternative to this arrangement, the bottom end 120 of the second wheel support member 104 may comprise a horizontal flange segment which may be secured with a bolt 144 or other suitable means to the horizontal support surface. In some embodiments, the flange segment of the bottom end 120 is configured to extend substantially completely between the second left and right side members 122, 124 to provide a degree of lateral stability to the second wheel support member 104.

In accordance with another embodiment of the invention, the apparatus 100 may comprise a first elongated horizontal mounting member 146 to which the mounting bracket 134 is bolted or otherwise secured and/or a second elongated horizontal mounting member 148 to which the bottom end 120 of the second wheel support member 104 is bolted or otherwise secured. In this embodiment, the first and second elongated horizontal mounting members 146, 148 are in turn supported on the horizontal support surface (e.g., the floor, the ground, a platform, etc.).

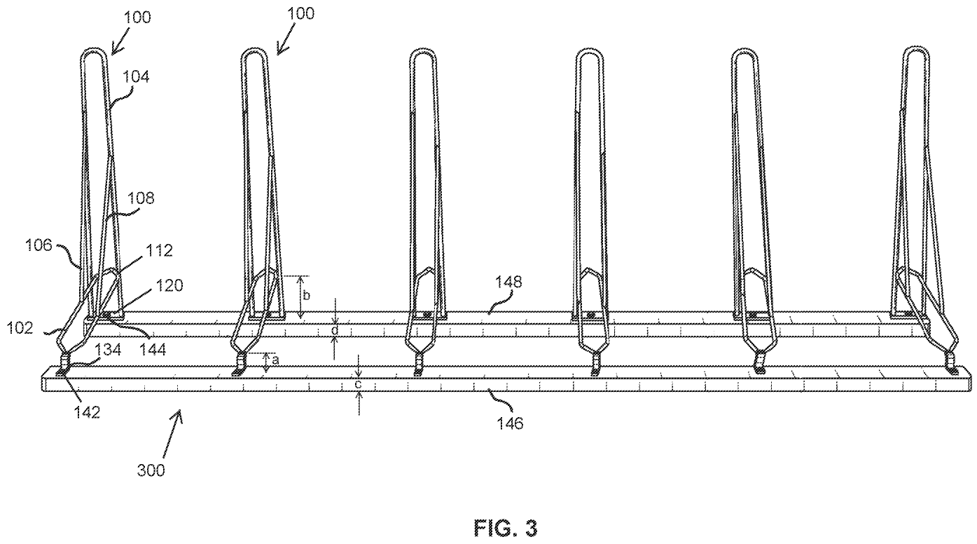

The inventors have observed that if the bicycle wheel positioned in the first wheel support member 102 is allowed to touch the horizontal support surface or the elongated horizontal mounting members 146, 148 (if present), the bicycle may appear unstable. Thus, in accordance with a further embodiment of the invention, the support apparatus 100 may be configured to maintain the wheel elevated above the horizontal support surface and/or the elongated horizontal mounting members. Referring to FIG. 3, for example, if the mounting bracket 134 has a height “a”, the distal end of the first wheel support member 102 is connected to the second wheel support member 104 a distance “b” above the bottom end 120 of the second wheel support member 104, and the first and second elongated horizontal mounting members 146, 148, if present, have respective heights “c” and “d” (which could be the same height), the combination of the dimensions a, b, c and d may be selected so that the first wheel support member 102 will elevate the wheel positioned therein above the horizontal support surface (i.e., the floor, the ground, etc.) and the elongated horizontal mounting members 146, 148 (if present). For example, if the elongated horizontal mounting members 146, 148 are not present in a particular configuration of the support apparatus, the dimensions a and b may be selected to maintain the wheel elevated above the horizontal support surface. In a similar manner, if both elongated horizontal mounting members 146, 148 are present, the dimensions a, b, c and d may be selected so that the heights a+c and b+d are sufficient to maintain the wheel elevated above the horizontal support surface and the elongated horizontal mounting members 146, 148. Likewise, if, e.g., only the second elongated horizontal mounting member 148 is present, the dimensions a, b and d may be selected so that the height a and the height b+d are sufficient to maintain the wheel elevated above the horizontal support surface and the second elongated horizontal mounting member 148.

In the example of the invention shown in FIG. 1, the first wheel support member is configured as a first elongated loop 102 and the second wheel support member is configured as a second elongated loop 104. According to some embodiments, the first elongated loop 102 comprises a V-shaped proximal end 110 and a V-shaped distal end 112, wherein a length of the first elongated loop 102 is measured from a base of the V-shaped proximal end to a base of the V-shaped distal end. In some cases, the first elongated loop 102 may be referred to as having a diamond shape due to the two V-shaped ends of the elongated metal loop.

According to some embodiments, the second elongated loop 104 may comprise a top end 118 and a bottom end 120, wherein a left side 114 and a right side 116 of the first elongated loop 102 are coupled, respectively, to a left side 122 and a right side 124 of the second elongated loop 104 closer to the V-shaped distal end 112 than the V-shaped proximal end 110. In some embodiments, the left side 114 and the right side 116 of the first elongated loop 102 are coupled, respectively, closer to the bottom end 120 than the top end 118. In some embodiments, the second elongated loop 104 supports the first elongated loop 102 in an elevated position spaced from the horizontal mounting surface. In some embodiments, the elevated position and the length of the first elongated loop 102 are selected to secure the bicycle wheel above the horizontal mounting surface by an amount sufficient so that the bicycle wheel does not contact the horizontal mounting surface.

According to some embodiments, the first or left strut 106 may be coupled at its lower end to the left side 114 of the first elongated loop 102 and at its upper end to the left side 122 of the second elongated loop 104. In some examples, the left strut 106 is coupled at its lower end to the left side 114 of the first elongated loop 102 at a lower left position, and the left strut 106 is coupled at its upper end to the left side 122 of the second elongated loop 104 at an upper left position.

According to some embodiments, the second or right strut 108 may be coupled at its lower end to the right side 116 of the first elongated loop 102 and at its upper end to the right side 124 of the second elongated loop 104. In some examples, the right strut 108 is coupled at its lower end to the right side 116 of the first elongated loop 102 at a lower right position, and the right strut 108 is coupled at its upper end to the right side 124 of the second elongated loop 104 at an upper right position. In some examples, the upper left position is located above the first elongated loop 102 a greater distance than the upper right position, and/or the lower left position is located closer to the second elongated loop 104 than the lower right position.

According to some embodiments, the left strut 106 forms a first angle 150 with the left side 114 of the first elongated loop 102. The first angle 150 may in some embodiments be greater than or equal to approximately sixty (60) degrees. Also, according to some embodiments, the right strut 108 forms a second angle 155 with the right side 116 of the first elongated loop 102. The second angle 155 may in some embodiments be less than or equal to approximately thirty (30) degrees.

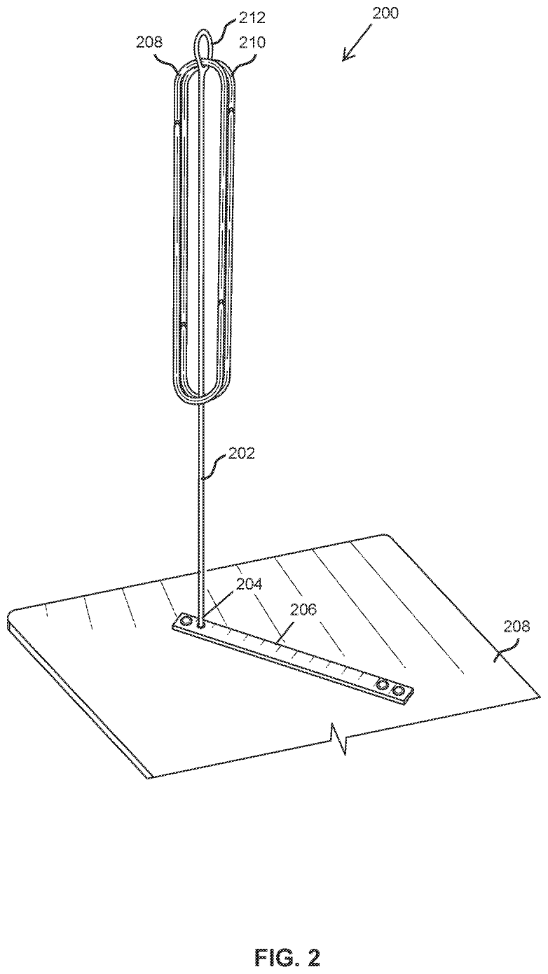

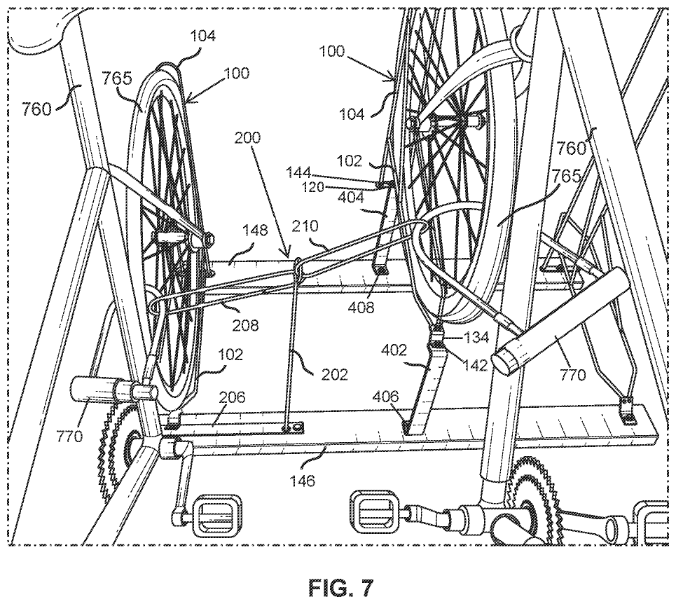

FIG. 2 shows an example of an apparatus for locking a vehicle to a vehicle support apparatus, such as the vehicle support apparatus 100 described above, according to aspects of the present disclosure. The locking apparatus of this example, generally 200, includes a vertical locking piece 202 having a bottom end 204 which is connected to a horizontal flange 206. The horizontal flange 206 is in turn secured to a horizontal support surface 208 by suitable means, such as bolts. Vertical locking piece 202 includes a number of (e.g., two) elongated locking links 208, 210 which are interlinked with a locking loop 212. Locking apparatus 200 may be used to lock one or more vehicles to a vehicle support apparatus, as will be further described with reference to FIG. 7.

FIG. 3 shows an example of another embodiment of a vehicle support apparatus according to aspects of the present disclosure. The example of FIG. 3 shows how multiple vehicle support apparatuses or “slots” 100 of the type described above in connection with FIG. 1 may be combined into a single vehicle support apparatus or “rack unit” 300. In the example shown in FIG. 3, the vehicle support apparatus 300 includes six slots 100. However, it should be understood that the vehicle support apparatus 300 may include any number of slots 100.

As shown in FIG. 3, each individual slot 100 of the vehicle support apparatus 300 may be secured to first and second elongated horizontal mounting members 146, 148. For example, the mounting bracket 134 to which the proximal end of the first wheel support member 102 is connected may be secured to the first elongated horizontal mounting member 146 with a bolt 142 or similar means. Likewise, the bottom end 120 of the second wheel support member 104 may be secured to the second elongated horizontal mounting member 148 with a bolt 144 or similar means.

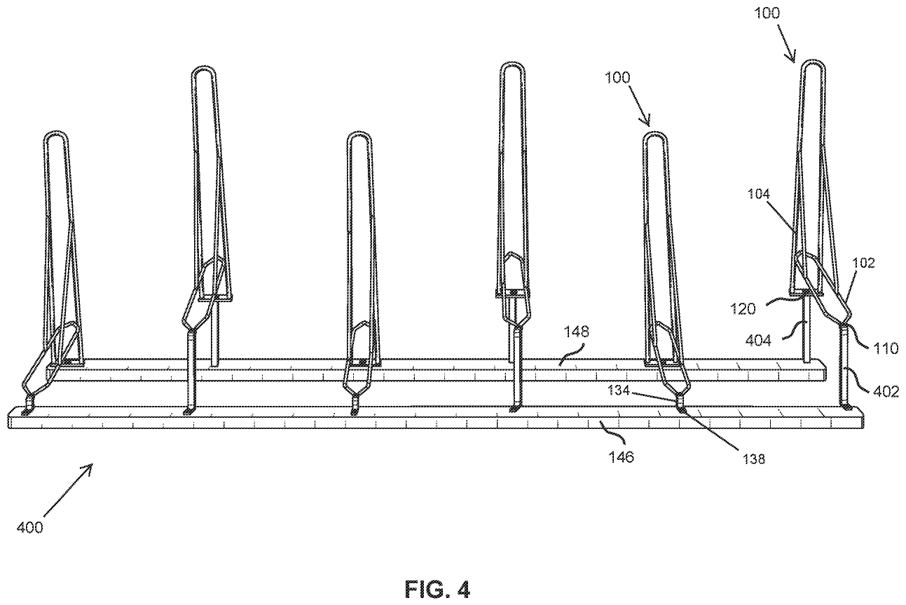

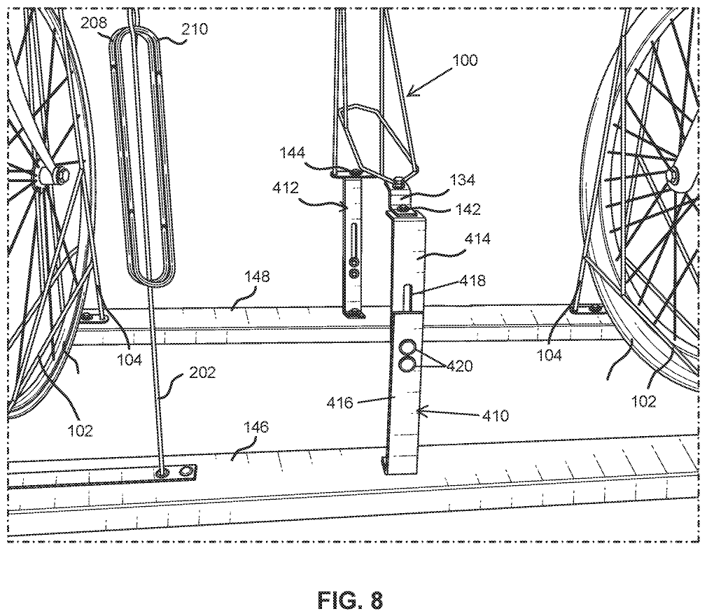

In some embodiments, the lateral spacing of the slots 100 in the vehicle support apparatus 300 may be variable and changeable. In addition, the vertical spacing of adjacent slots 100 above the elongate horizontal mounting members 146, 148 may be variable and adjustable, as will be described with reference to FIGS. 4 and 8. Also, the slots 100 may accommodate rear derailleurs and disk brake rotors of various sizes. Further, various widths of slots 100 may be available (e.g., up to 1.25 inches (32 mm), up to 2.3 inches (60 mm), up to 3 inches (76 mm), etc.), where thinner wheels or thinner tires will fit in wider slot widths. The vehicle support apparatus may also be provided with one or more locking apparatuses 200, as will be described with reference to FIGS. 7 and 8.

The elongated horizontal mounting members 146, 148 may be made of wood, plastic, metal, or other materials. In some examples, the slots 100 and the locking apparatuses 200 may be made of stainless steel so as to be less prone to rusting or corrosion. Further, wood-based models of the apparatuses described herein may be stained, painted, or otherwise protected or decorated as desired.

FIG. 4 shows an example of another embodiment of a vehicle support apparatus according to aspects of the present disclosure. The vehicle support apparatus shown in FIG. 4, generally 400, includes six vehicle support apparatuses or slots 100 of the type described above with reference to FIG. 1. FIG. 4 shows how the vertical height of the slots 100 relative to the horizontal support surface or the first and second elongated horizontal mounting members 146, 148 may be adjustable via the use of first and second risers 402, 404. For example, every other slot 100 may employ first and second risers 402, 404 in order to elevate that slot over the adjacent slots. This arrangement eliminates interference between the handlebars of bicycles parked in adjacent slots 100 and therefore makes parking and removing the bicycles easier. According to some embodiments, the first riser 402 may be coupled between the proximal end 110 of the first wheel support member 102 and the first elongated horizontal mounting member 146 (or directly to the horizontal support surface). For example, the upper end of the first riser 402 may be bolted or welded to the proximal end 110 of the first wheel support member 102 and the lower end of the first riser may be bolted to the first elongated horizontal mounting member. In some examples in which the proximal end 110 of the first wheel support member 102 is connected to a mounting bracket 134, the upper end of the first riser 402 may be connected, such as bolted, to the lower end portion 138 of the mounting bracket 134 and the lower end of the first riser may be bolted to the first elongated horizontal mounting member 146 (or directly to the horizontal support surface). According to some embodiments, the second riser 404 may be coupled between the bottom end 120 of the second wheel support member 104 and the second elongated horizontal mounting member 148 (or the horizontal support surface). For example, the upper end of the second riser 404 may be bolted or welded to the bottom end 120 of the second wheel support member 104 and the bottom end of the second riser may be bolted to the second elongated horizontal mounting member 148. The first and second risers 402, 404 may have the same height or different heights. In addition, as will be described with reference to FIG. 8, one or both of the first and second risers 402, 404 may be adjustable in height.

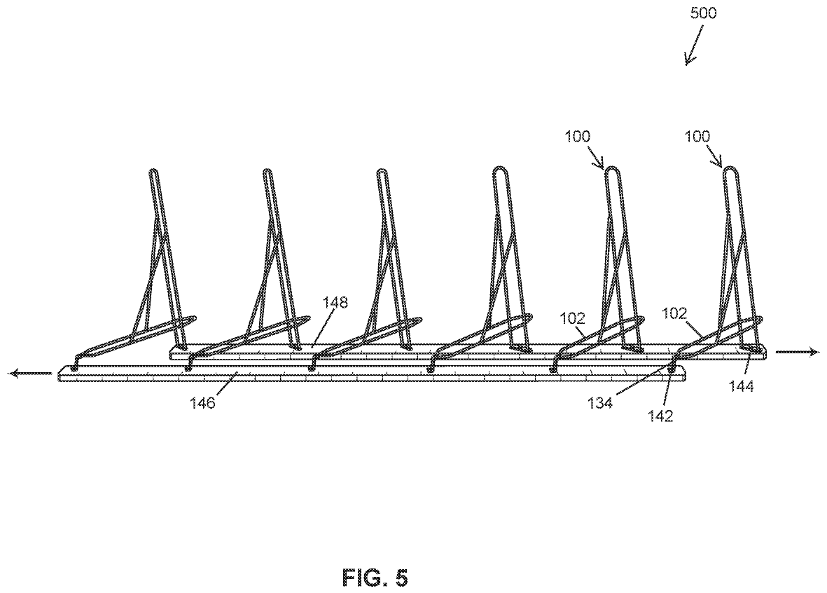

FIG. 5 shows an example of another embodiment of a vehicle support apparatus according to aspects of the present disclosure. The vehicle support apparatus of FIG. 5, generally 500, includes six slots 100 of the type described with reference to FIG. 1. FIG. 5 illustrates how the angular relationship between the slots 100 and the first and second elongated horizontal support members 146, 148 may be changed to suit a particular vehicle parking configuration. In one example of the apparatus 500, the angular relationship may be continuously variable from about +70 degrees to about −70 degrees from a normal position in which the first wheel support member 102 is approximately perpendicular to the first and second elongated horizontal mounting members 146, 148 in a horizontal plane. This may be accomplished by loosening the bolts 142 securing the mounting brackets 134 to the first elongated horizontal mounting member 146 and the bolts 144 securing the second wheel support members 104 to the second elongated horizontal mounting member and then sliding the first and second elongated horizontal mounting members longitudinally relative to each other, as shown by the arrows in FIG. 5. In this manner, the elongated horizontal mounting members 146, 148 may be brought closer together in order to accommodate vehicles at various angles.

FIG. 5 illustrates a left-hand angle parking arrangement for the apparatus 500. However, the apparatus 500 is not limited to left-hand arrangements, as moving the first and second elongated horizontal mounting members 146, 148 in a direction opposite the arrows in FIG. 5 would result in a right-hand angle parking arrangement for the apparatus 500. The different angled parking arrangements may be useful, for instance, for parking vehicles at a left-hand angle against a left-side wall or a right-hand angle against a right-side wall. In some embodiments, the elevated position and the length of the first elongated loop 102, coupled with aspects of mounting bracket 134, are selected to secure the bicycle wheel above the elongated horizontal mounting members 146, 148, while at any angle between plus or minus 70 degrees, by an amount sufficient so that the bicycle wheel does not contact the horizontal support surface (e.g., the floor, the ground, etc.) and the elongated horizontal mounting members 146, 148. Additionally, this angled parking arrangement reduces the horizontal surface area of apparatus 500 when the apparatus is to be stowed, transported, etc.

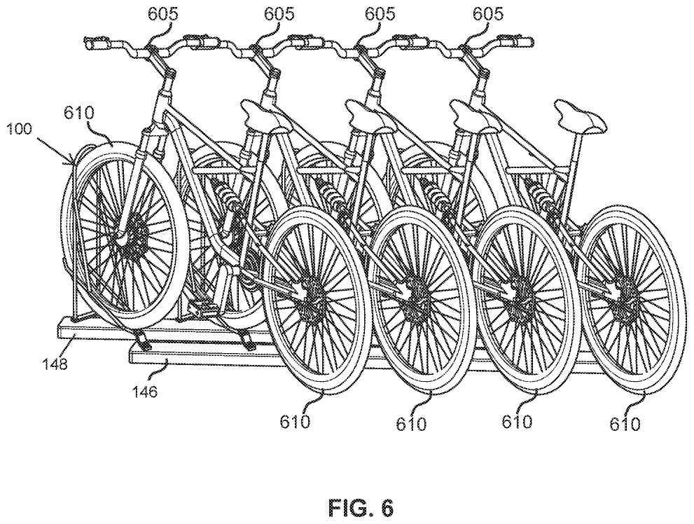

FIG. 6 shows an example of the vehicle support apparatus 500 being used to secure four bicycles 605, each of which includes a front wheel 610 and a rear wheel 610. In this example, the first and second elongated horizontal mounting members 146, 148 are positioned on the horizontal support surface (e.g., the floor, ground, platform, etc.), and the front wheel 610 of each bicycle 605 is secured in a corresponding slot 100 while the rear wheel 610 rests on the horizontal support surface.

FIG. 7 shows an example of yet another embodiment of a vehicle support apparatus according to aspects of the present disclosure. The vehicle support apparatus of this embodiment is similar to the vehicle support apparatuses described above. In this embodiment, however, the vehicle support apparatus also includes a number of locking apparatuses 200 of the type described above in connection with FIG. 2. In this example, the locking apparatus 200 is secured via its horizontal flange 206 to the first elongated horizontal mounting member 146 of the vehicle support apparatus. As shown in FIG. 7, the wheels 765 of two bicycles 760 are supported in adjacent slots 100 of the vehicle support apparatus, and each wheel is secured to the frame of its respective bicycle by a corresponding lock 770. Each lock 770 in turn is secured to the vertical locking piece 202 by a corresponding locking link 208, 210. In this manner, the locking apparatus 200 secures the bicycles 760 to the first elongated horizontal mounting member 146 and, thus, to the vehicle support apparatus as a whole.

In the embodiment of FIG. 7, one of the slots 100 is elevated above the elongated horizontal mounting members 146, 148 by first and second risers 402, 404 of the type described above in connection with FIG. 4. In this example, the mounting bracket 134 to which the proximal end 110 of the first wheel support member 102 is attached is connected to the top of the first riser 402 by a bolt 142, and the bottom of the first riser is connected to the first elongated horizontal mounting member 146 by a second bolt 406. Similarly, the bottom end 120 of the second wheel support member 104 is connected to the top of the second riser 404 by a bolt 144, and the bottom of the second riser is connected to the second elongated horizontal mounting member 148 by a second bolt 408.

FIG. 8 shows an example of an embodiment of an adjustable riser system for varying the height of a slot 100 above the first and second elongated horizontal mounting members 146, 148. In this embodiment, the adjustable riser system includes a first adjustable riser 410 which is connected to the first elongated horizontal mounting member 146 and a second adjustable riser 412 which is connected to the second elongated horizontal mounting member 148. Each adjustable riser 410, 412 includes an elongated top piece 414 which is adjustably connected to an elongated bottom piece 416. For example, the top piece 414 may comprise a longitudinal slit 418 which is configured to slidably receive a number of bolts 420 that are secured in corresponding holes in the bottom piece 416. When firmly tightened, the bolts 420 rigidly secure the top piece 414 to the bottom piece 416 and prevent these pieces from moving relative to each other. When the bolts 420 are loosened, however, the top piece 414 may be moved longitudinally relative to the bottom piece 416 to thereby adjust the height of the riser 410, 412 and, thus, the slot 100.

FIG. 9 shows an example of a vehicle support apparatus according to aspects of the present disclosure. The vehicle support apparatus shown in FIG. 9 may be an example of, or may include aspects of, the vehicle support apparatus described above with reference to FIG. 1. In some cases, the apparatus of FIG. 9 may be referred to as, or may include aspects of, a slot or slot apparatus as described herein. The example shown includes a left-side intersection 900 of the first or left strut and a right-side intersection 910 of the second or right strut. The left-side intersection 900 of the left strut is an example of, or includes aspects of, the corresponding element described with reference to FIG. 1. In one embodiment, the left-side intersection 900 of the left strut includes first angle 905. In some embodiments, the first angle 905 may be greater than or equal to approximately sixty (60) degrees. For example, the first angle 905 may be 65 degrees. The right-side intersection 910 of the right strut is an example of, or includes aspects of, the corresponding element described with reference to FIG. 1. In one embodiment, the right-side intersection 910 of the right strut includes second angle 915. In some embodiments, the second angle 915 may be less than or equal to approximately thirty (30) degrees. For example, the second angle 915 may be 25 degrees.

FIG. 9 also shows example dimensions 920-954 of a vehicle support apparatus (e.g., a slot apparatus) according to aspects of the present disclosure. Various dimensions are possible, and the following examples are not limiting of the possible dimensions of the apparatus.

Dimension 920 may be, for example, a length of 24.5, 26.5 or 27 inches. Dimension 922 may be, for example, an angle of 12 degrees. Dimension 924 may be, for example, an angle of 90 degrees. Dimension 926 may be, for example, a length of 1.75 inches. Dimension 928 may be, for example, a length of 5.25 inches. Dimension 930 may be, for example, a length of 13.25 or 13.5 inches. Dimension 932 may be, for example, a length of 15.25 inches. Dimension 934 may be, for example, a length of 1.75 inches. Dimension 936 may be, for example, a length of 1.25 inches. Dimension 938 may be, for example, a length of 2.75 inches. Dimension 940 may be, for example, a length of 3 or 3.75 inches. Dimension 942 may be, for example, a radius of 0.65, 1.14 or 1.56 inches. Dimension 944 may be, for example, a length of 19.75 inches. Dimension 946 may be, for example, a length of 18.75 inches. Dimension 948 may be, for example, a length of 0.5 inches. Dimension 950 may be, for example, a length of 1.5 or 1.87 inches. Dimension 952 may be, for example, a length of 0.5 inches. Dimension 954 may be, for example, a length of 1 inch.

Generally, the first wheel support member or elongated loop 102 may be designed such that an end to end length accommodates a variety of wheel sizes and keeps the wheels from touching the elongated horizontal mounting members and the horizontal support surface on which the elongated horizontal mounting members are positioned (e.g., the ground, the floor, etc.). The first elongated loop may be designed with a width to control tightness of various tire sizes. The first elongated metal loop may be designed with an angle of diamond bends (e.g., V-shaped ends), or location of diamond bends, to keep overall diamond dimensions at a minimum while still accommodating a variety of wheel and tire sizes. The first elongated metal loop may be designed based on a height of the proximal end and a height of the distal end above a surface of the elongated horizontal mounting members and the ground. The first elongated loop may be designed based on a distance or location of a distal end from one edge of an elongated horizontal mounting member. The first elongated loop may be designed such that a second elongated loop attaches to the first elongated loop to maintain an elevated position of first elongated loop and support the tire at a location at or near the top of the tire.

The dimensions described herein may maintain the tire off of the ground and off of the elongated horizontal mounting members (if present) for a variety of wheel and tire sizes and a variety of apparatus angles. Left and right struts may be sized and placed to accommodate (e.g., avoid contact with) many sizes and variations of bicycle wheel components such as large disk brake rotors for both front and rear wheels, various sizes of rear derailleurs on multispeed bikes, etc.

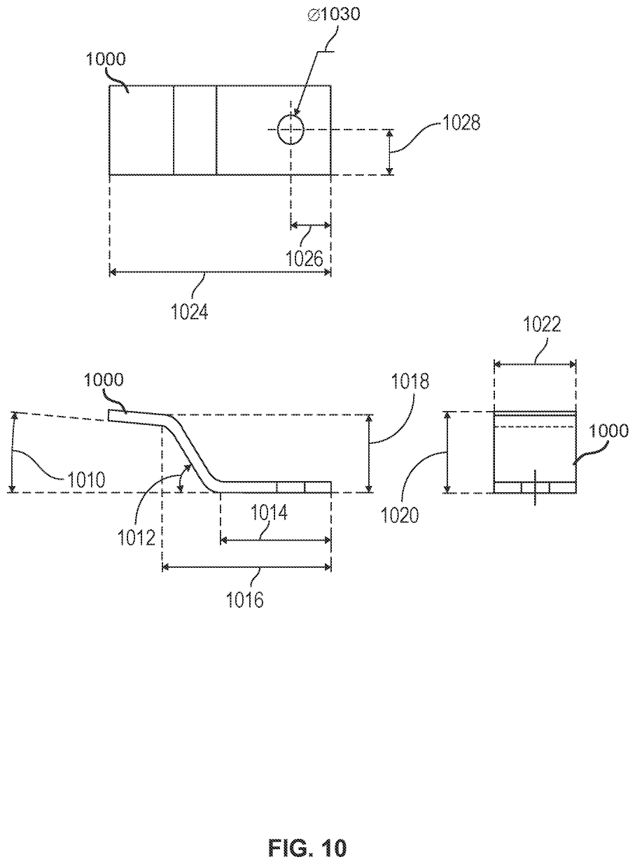

FIG. 10 shows an example of a mounting bracket 1000, similar to mounting bracket 134 described above, according to aspects of the present disclosure. FIG. 10 shows example dimensions 1010-1030 of the mounting bracket 1000 according to aspects of the present disclosure. Dimension 1010 may be, for example, an angle of 5 degrees. Dimension 1012 may be, for example, an angle of 56 degrees. Dimension 1014 may be, for example, a length of 1.5 inches. Dimension 1016 may be, for example, a length of 2 inches. Dimension 1018 may be, for example, a length of 0.88 inches. Dimension 1020 may be, for example, a length of 0.91 inches. Dimension 1022 may be, for example, a length of 1 inch. Dimension 1024 may be, for example, a length of 2.75 inches. Dimension 1026 may be, for example, a length of 0.5 inches. Dimension 1028 may be, for example, length of 0.5 inches. Dimension 1030 may be, for example, a diameter of 5/16 inches.

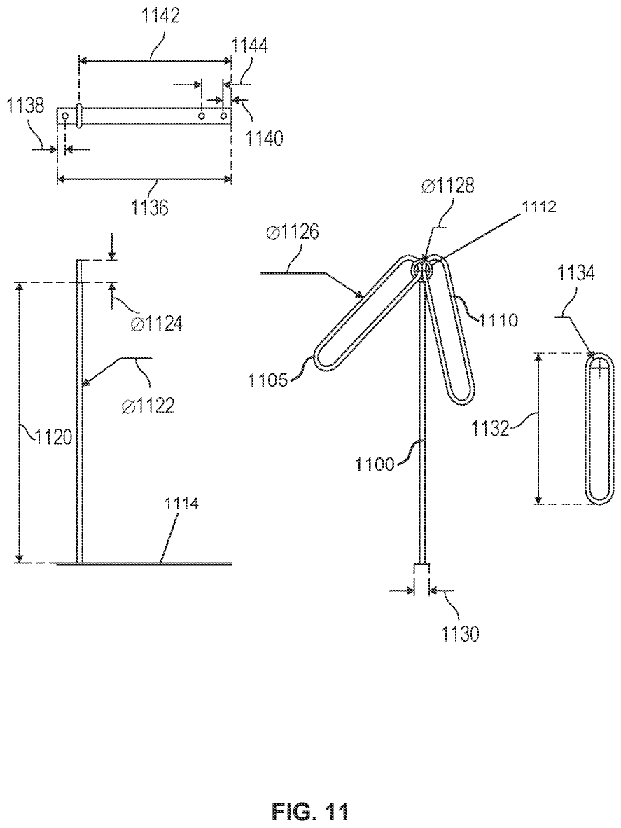

FIG. 11 shows an example of an apparatus for locking a vehicle to a vehicle support apparatus according to aspects of the present disclosure. The locking apparatus shown in FIG. 11 may be an example of, or may include aspects of, the locking apparatus 200 described above with reference to FIG. 2. The example shown includes a vertical locking piece 1100, a first locking link 1105, a second locking link 1110, a locking loop 1112 and a horizontal mounting flange 1114.

FIG. 11 shows example dimensions 1120-1142 of the locking apparatus according to aspects of the present disclosure. Dimension 1120 may be, for example, a length of 18.5 inches. Dimension 1122 may be, for example, a diameter of ⅜ inches. Dimension 1124 may be, for example, a diameter of 1.5 inches. Dimension 1126 may be, for example, a diameter of 5/16 inches. Dimension 1128 may be, for example, a diameter of 1 inch. Dimension 1130 may be, for example, a length of 1 inch. Dimension 1132 may be, for example, a length of 10 inches. Dimension 1134 may be, for example, a radius of 0.65 inches. Dimension 1136 may be, for example, a length of 12.15 inches. Dimension 1138 may be, for example, a length of 0.5 inches. Dimension 1140 may be, for example, a length of 0.5 inches. Dimension 1142 may be, for example, a length of 10.75 inches. Dimension 1144 may be, for example, a length of 2 inches.

While the invention herein disclosed has been described by means of specific embodiments, examples and applications thereof, numerous modifications and variations could be made thereto by those skilled in the art without departing from the scope of the invention set forth in the claims.

What is claimed is:

1. An apparatus for supporting wheeled vehicles in an upright position, the apparatus comprising:
a first elongated wheel support member comprising a proximal end, a distal end and a pair of first elongated left and right side members connecting the proximal and distal ends;
a second elongated wheel support member comprising a top end, a bottom end and a pair of second elongated left and right side members connecting the top and bottom ends;
wherein the first wheel support member is connected near its distal end to the second wheel support member;
a first strut which extends between the first and second left side members; and
a second strut which extends between the first and second right side members;
wherein the first strut is connected to the first left side member at a first connection point and the second strut is connected to the first right side member at a second connection point; and
wherein the first and second connection points are spaced unequally from the distal end of the first wheel support member.

2. The apparatus of claim 1, wherein the first connection point is located closer to the distal end of the first wheel support member than the second connection point.

3. The apparatus of claim 1 or 2, wherein the first strut is connected to the second left side member at a third connection point and the second strut is connected to the second right side member at a fourth connection point, and wherein the third and fourth connection points are spaced unequally from the top end of the second wheel support member.

4. The apparatus of claim 3, wherein the third connection point is located closer to the top end of the second wheel support member than the fourth connection point.

5. The apparatus of claim 1, further comprising a vertically extending mounting bracket having an upper end portion to which the proximal end of the first wheel support member is connected, a lower end portion which is connectable to a horizontal support surface, and a middle portion which extends between the upper and lower end portions.

6. The apparatus of claim 5, wherein the middle portion is inclined toward the distal end of the first wheel support member.

7. The apparatus of claim 5, further comprising at least one of a first elongated horizontal mounting member to which the mounting bracket is secured and a second elongated horizontal mounting member to which the bottom end of the second wheel support member is secured.

8. The apparatus of claim 7, wherein a horizontal angle between the first wheel support member and the first or second horizontal mounting member is adjustable.

9. The apparatus of claim 5, further comprising at least one of a first vertically extending riser which is connected to and extends downwardly from the mounting bracket and a second vertically extending riser which is connected to and extends downwardly from the bottom end of the second wheel support member.

10. The apparatus of claim 9, wherein at least one of said first and second risers is adjustable in length.
